(19) United States
(12) Patent Application Publication
(10) Pub. No.: US 2013/0185356 A1
(43) Pub. Date: Jul. 18, 2013

(54) CONFERENCE SUPPORTING SYSTEM

(71) Applicants: Akihiko Mizutani, Shizuoka-ken (JP); Kazuhiro Ogura, Kanagawa-ken (JP); Shinji Makishima, Shizuoka-ken (JP); Toshihiro Ida, Shizuoka-ken (JP); Yusuke Hamada, Shizuoka-ken (JP)

(72) Inventors: Akihiko Mizutani, Shizuoka-ken (JP); Kazuhiro Ogura, Kanagawa-ken (JP); Shinji Makishima, Shizuoka-ken (JP); Toshihiro Ida, Shizuoka-ken (JP); Yusuke Hamada, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/693,262

(22) Filed: Dec. 4, 2012

Related U.S. Application Data
(60) Provisional application No. 61/577,180, filed on Dec. 19, 2011.

(51) Int. Cl. H04L 29/06

(52) U.S. Cl. CPC H04L 65/403
USPC 709/204

(57) ABSTRACT

According to one embodiment, a conference supporting system includes: a material-data managing section configured to manage conference material data; a material-data distributing section configured to distribute material data of the material-data managing section according to a distribution request; information terminal sections configured to receive the material data through communication with the material-data distributing section and transmit rendering data generated by participants; and an additional-data managing section configured to manage, as additional data, the rendering data transmitted from the information terminal sections, distribute, to another information terminal section, rendering data transmitted from a specific information terminal section, and determine the distribution of the rendering data according to an instruction to continuously display or not to continuously display the rendering data.

### CROSS-REFERENCE TO RELATED APPLICATION

This application is based upon and claims the benefit of priority from: U.S. provisional application 61/577180, filed on Dec. 19, 2011; the entire contents of which are incorporated herein by reference.

### FIELD

Embodiments described herein relate generally to, in an electronic conference system, a technique for treating data rendered by a presenter or the like during a conference.

### BACKGROUND

For a paperless conference, an electronic conference system is proposed that converts a distributed material used in a conference, a lecture, a training course, or the like into an electronic form and displays the distributed material on viewing terminals of participants. The electronic conference system sets pages of the distributed material according to, for example, the progress of agenda or lectures and the progress of explanation of a presenter. Therefore, even if the presenter announces a new matter not included in the distributed material during presentation of one theme, additional data for adding the new announced matter to the distributed material may not be able to be stored. Therefore, if a plurality of presenters make presentation in order, additional data presented by the preceding presenter may not be able to be stored.

Further, there is a demand for a significant use of additional data written in the viewing terminals by the participants (people other than the presenters).

### DESCRIPTION OF THE DRAWINGS

FIG. 1 is a block diagram of a conference supporting system according to an embodiment;

FIG. 2 is a diagram of a display screen of a viewing terminal in the embodiment;

FIG. 3 is a diagram of a display screen for a document list in the viewing terminal shown in FIG. 2;

FIG. 4 is a diagram of a state in which an image is rendered on the screen of the viewing terminal shown in FIG. 2;

FIG. 5 is a diagram of a list of a conference ID management database stored in a material data distributing section;

FIG. 6 is a diagram of a list of an item-of-business management database;

FIG. 7 is a diagram of a rendering data list of a first presenter in an addition database for display;

FIG. 8 is a diagram of a rendering data list of the first presenter and a second presenter in the addition database for display;

FIG. 9 is a diagram of a list of the addition database for display obtained when the second presenter does not take over rendering data of the first presenter;

FIG. 10 is a diagram of a list of the addition database for display obtained when a conference of an agenda 1 ends;

FIG. 11 is a diagram of an example of a management list in an additional-data managing section;

FIG. 12 is a diagram of another example of the management list in the additional-data managing section;

FIG. 13 is a diagram of an example of a management list in a personal-additional-data managing section;

FIG. 14 is a diagram of another example of the management list in the personal-additional-data managing section;

FIG. 15 is a flowchart for explaining a flow of additional writing processing; and

FIG. 16 is a flowchart for explaining a flow of processing in a scene 3.

### DETAILED DESCRIPTION

In general, according to one embodiment, a conference supporting system includes: a material-data managing section configured to manage conference material data; a material-data distributing section configured to distribute material data of the material-data managing section according to a distribution request; information terminal sections configured to receive the material data through communication with the material-data distributing section and transmit rendering data generated by participants; and an additional-data managing section configured to manage, as additional data, the rendering data transmitted from the information terminal sections, distribute, to another information terminal section, rendering data transmitted from a specific information terminal section, and determine the distribution of the rendering data according to an instruction to continuously display or not to continuously display the rendering data.

The conference supporting system according to this embodiment is explained in detail below with reference to the accompanying drawings.

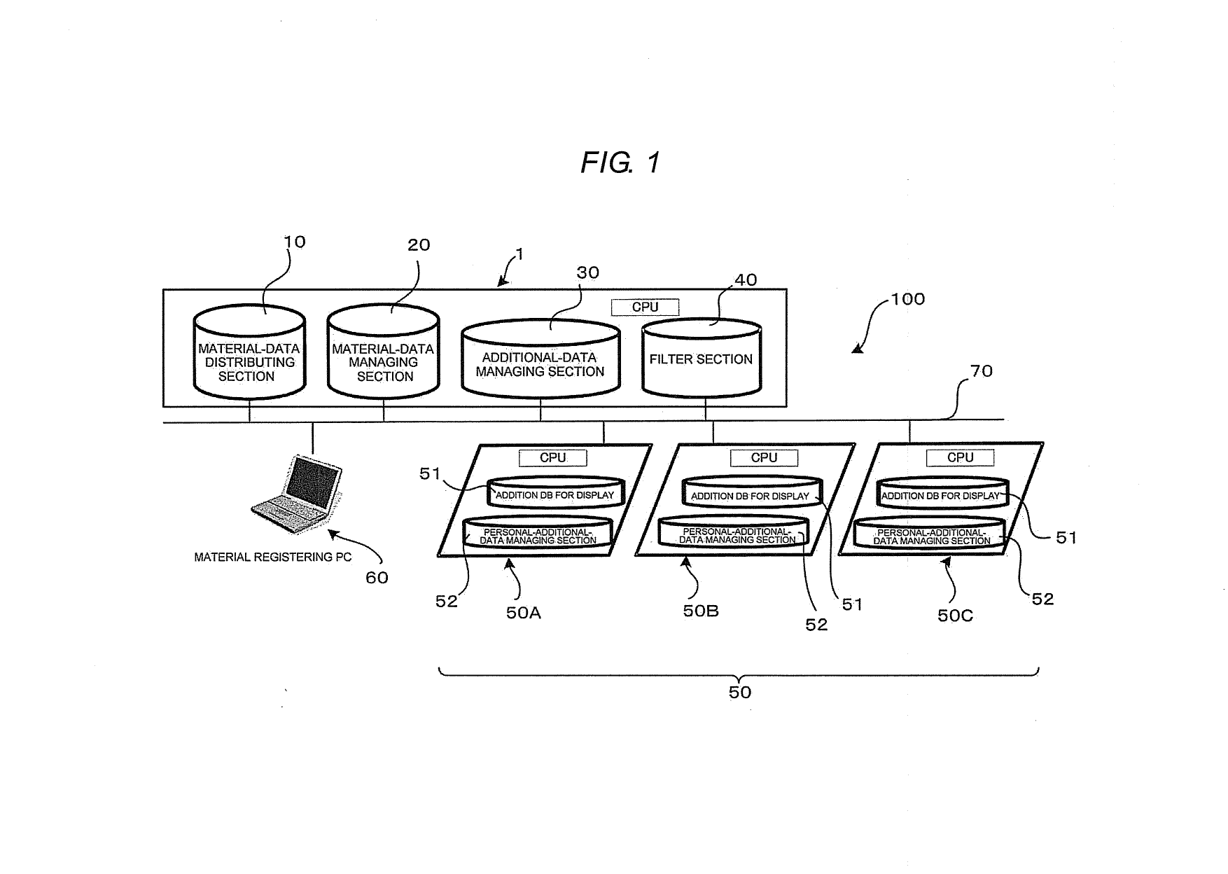

FIG. 1 is a block diagram of the conference supporting system according to this embodiment.

A conference supporting system 100 according to this embodiment includes a server 1, a plurality of viewing terminals 50 (50A, 50B, 50C, etc.), and a personal computer (PC) for material registration 60. The server 1 includes a material-data distributing section 10 for distributing a material; a material-data managing section 20 configured to manage material data for each of conferences; an additional-data managing section 30 configured to manage additional data added by a conference participant during a conference; a filter section 40 configured to filter display of the additional data; and a CPU configured to control the entire server 1.

The material-data distributing section 10, the material-data managing section 20, the additional-data managing section 30, the filter section 40, the plurality of viewing terminals 50, and the personal computer (PC) for material registration 60 are connected to a network 70.

The viewing terminals 50 (50A, 50B, 50C, etc.) include CPUs configured to control the viewing terminals 50, addition databases (DBs) for display 51, and personal-additional-data managing sections 52. The addition databases (DBs) for display 51 and personal-additional-data managing sections 52 may be the same as the additional-data managing section 30 provided on the outside.

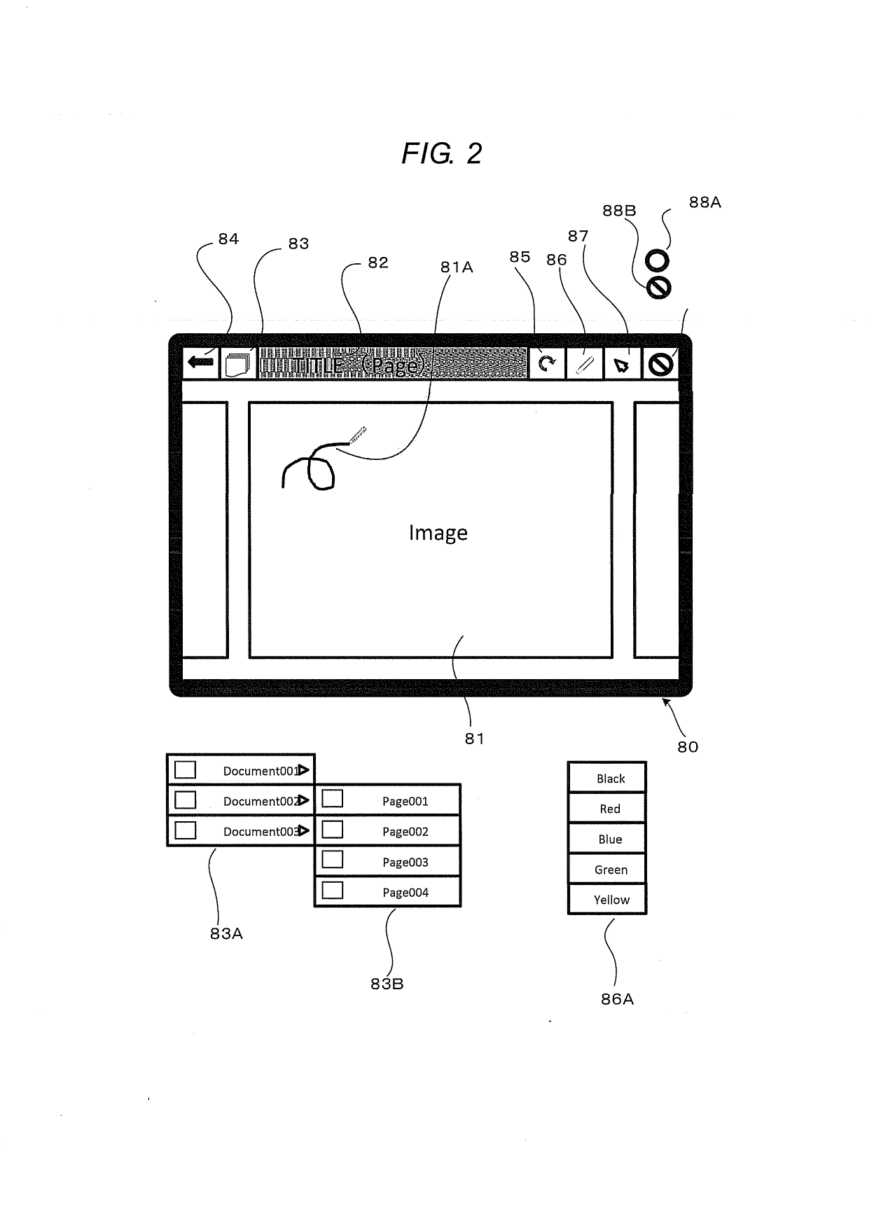

As shown in FIG. 2 as an example, the viewing terminal 50 is a terminal apparatus of a tablet type. The viewing terminal 50 includes a screen 80 of a touch panel type. In the screen 80, a title display section 82, a document-list selection section 83, a logout instruction section 84, a download selection section 85, a rendering-pen-list selection section 86, an instruction-bar display section 87, and a mode-switch instruction section 88 are arranged around a main body section 81 in which an image is displayed.

When a user touches the mode-switch instruction section 88, a display section 88A indicating a screen sharing mode (referred to as sharing mode) having a different pattern and a display section 88B indicating a screen private mode (referred to as independent mode) are alternately switched.

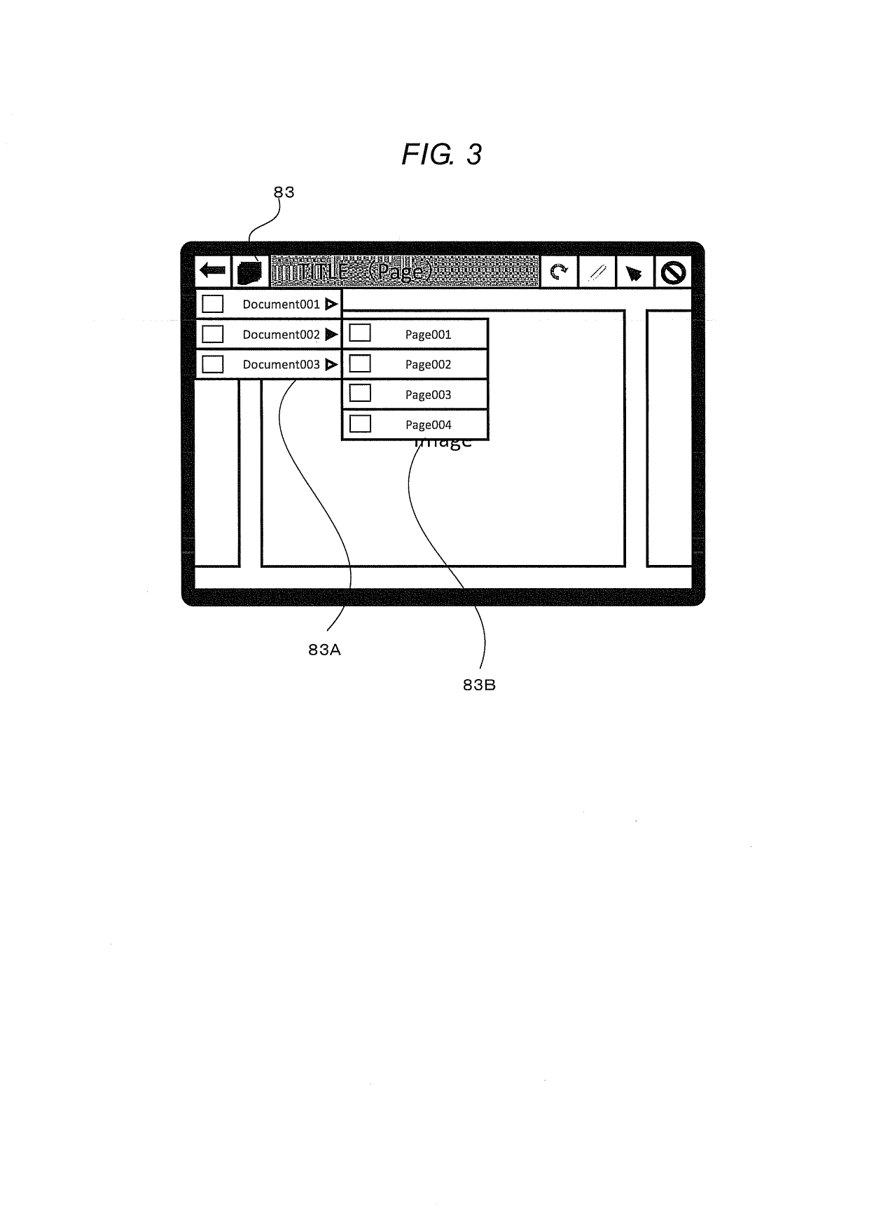

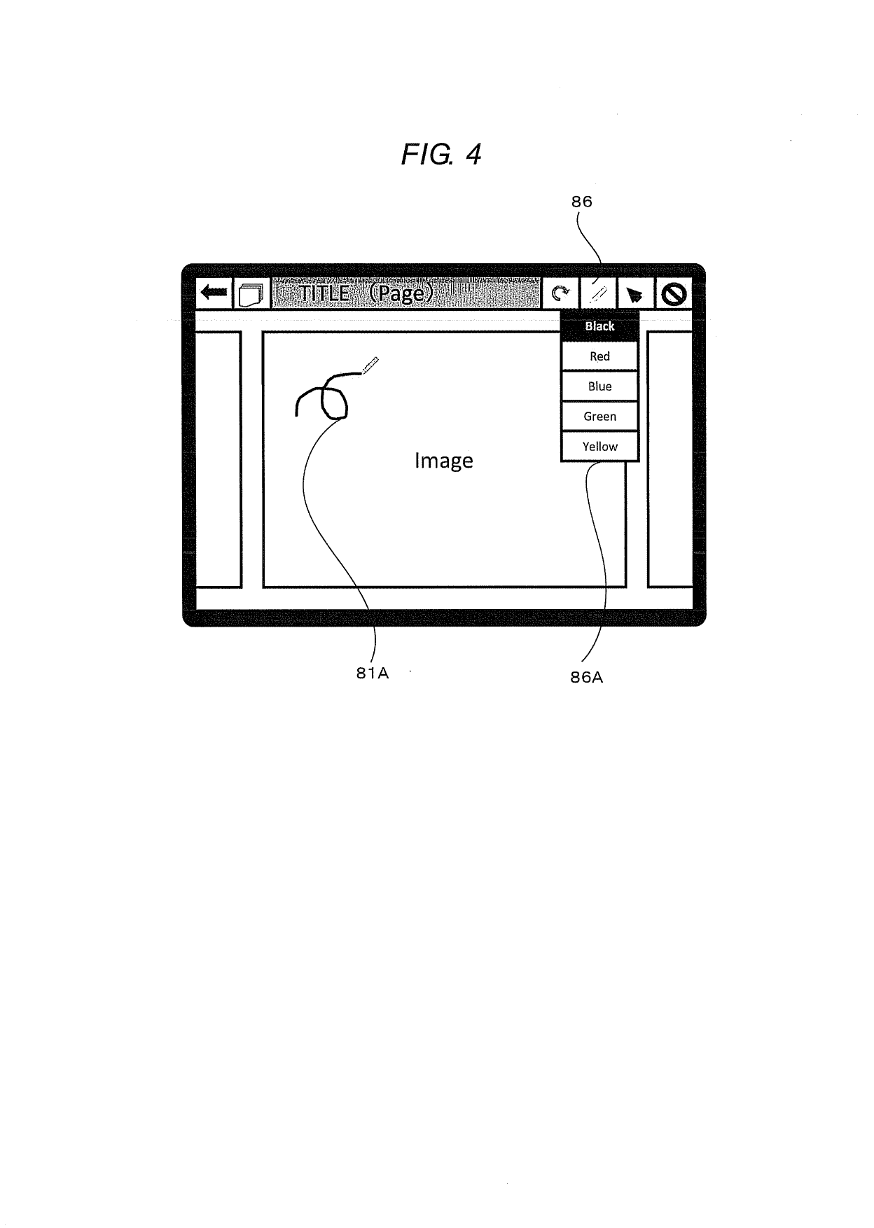

When the user touches the rendering-pen-list instruction section 86, a pen-list display section 86A of a plurality of colors for rendering is displayed to enable the user to set a color. The user can freely render an image 81A such as a character or a figure in the set color on the main body section 81. When the user touches the document-list selection section 83, a document-list display section 83A is displayed. When the user touches a document of a document list displayed on the document-list display section 83A, the document is displayed. When the user touches a page number of a page display section 83B, the preset page jumps to a desired page. In FIG. 3, a document “002” displayed on the document-list display section 83A is selected. In FIG. 4, “Black” is selected in the pen-list display section 86A.

In the conference supporting system 100, material data is sent from the PC for material registration 60 to the material-data managing section 20 and managed. Upon receiving a request for a conference material from the viewing terminal 50 prepared for the conference participant, the material-data distributing section 10 sends data managed by the material-data managing section 20 to the viewing terminal 50.

The conference supporting system 100 according to this embodiment separately manages, in the additional-data managing section 30 functioning as a server, data (additional data) rendered by a current presenter currently making presentation in a conference during the presentation using the viewing terminal 50 of the presenter and data (additional data) rendered by a current participant in the conference other than the presenter using the viewing terminal 50 of the participant. The viewing terminal 50 includes the personal-additional-data managing section 52 in a local storage during offline (in an independent mode) . In the viewing terminal 50, concerning the addition DB for display 51, a pointer of additional data is managed every time a presenter right changes.

Consequently, according to an action of acquisition of the presenter right by the current participant, it is possible to merge (upload) additional data of the current participant to the addition DB for display 51 used so far, independently display the additional data of the current participant, and select an item to be displayed.

Since the filter section 40 is used, it is possible to switch contents to be displayed (per user, per time, etc.).

As shown in FIG. 5, the material-data distributing section 10 includes a conference ID and date and time, start time, a conference name, and an administrator of a conference . A plurality of the conference administrators can be designated. Further, as shown in FIG. 6, the material-data distributing section 10 includes an agenda name, a required time (not shown), and a presenter to correspond to the conference ID. The presenter may be or may not be set in default.

In a conference ID “2010091711000-management conference”, the presenter is changed every time an acquisition request for a presentation right is generated after the start of the conference. As agenda, “agenda 1”, “agenda 2”, and “agenda 3” are scheduled. It is determined that an employee A, an employee B, and an employee C are presenters in the agenda 1, the agenda 2, and the agenda 3, respectively.

FIGS. 7 to 10 are diagrams of lists of people having the presenter right from the start to the end of the conference of the conference ID “2010091711000-management conference”. The lists are recorded in the addition DB for display 51. In the lists, a conference ID, an agenda name, a presenter, rendering data, and a pointer are recorded.

The list shown in FIG. 7 indicates that the conference of the conference ID “2010091711000-management conference” is started and the employee A, who is a first presenter, performs writing on the viewing terminal 50 during presentation concerning the agenda 1. A matter written by the employee A, who is the first presenter, is represented as rendering data A. The rendering data includes items such as a document name, a page, and a coordinate position. A pointer is added every time a presenter has the presenter right. FIG. 10 is a diagram of a list obtained at a point when the agenda 1 of the conference ends.

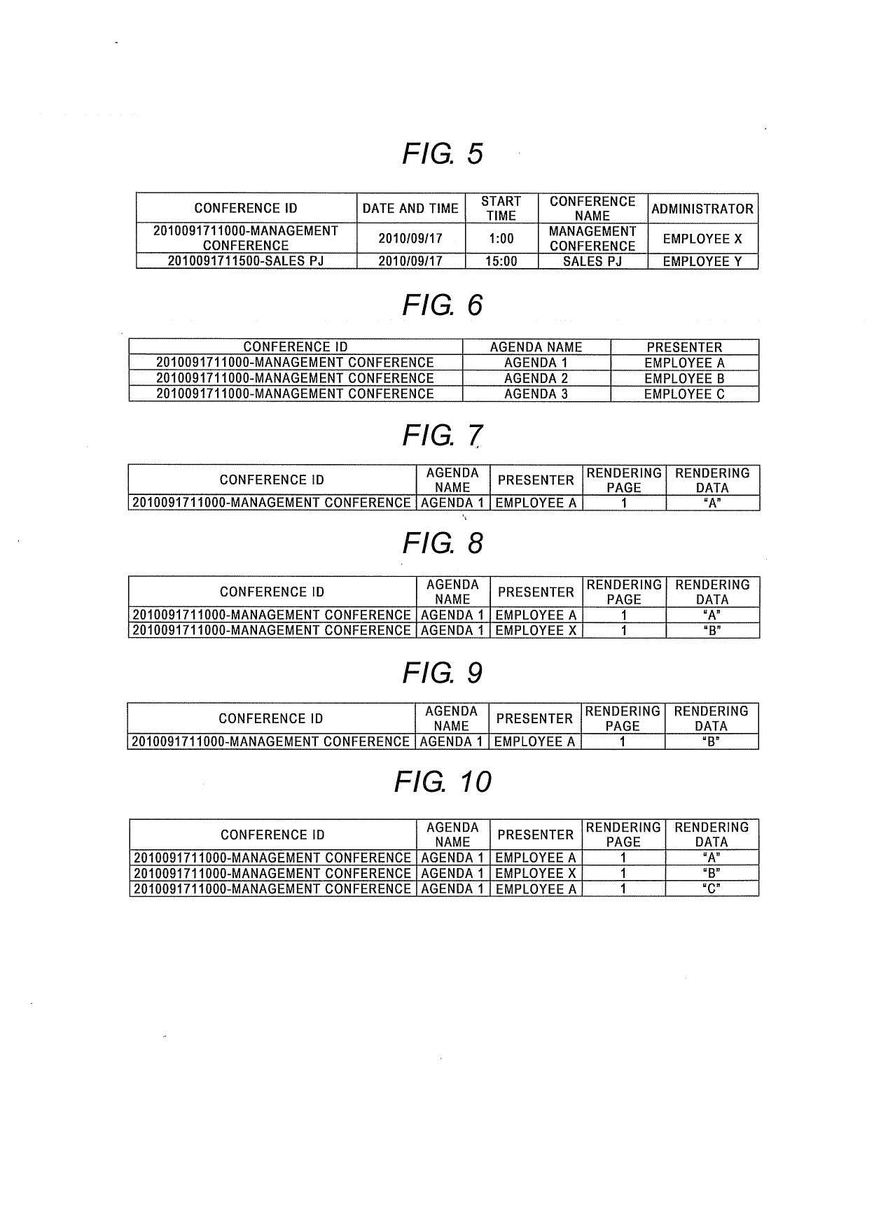

In this case, as shown in FIG. 7, the first presenter of the agenda 1 is the employee A. However, as shown in FIG. 8, halfway in a first page of distributed data, an employee X becomes a second presenter and acquires the presenter right. Further, as shown in FIG. 10, the employee A becomes a third presenter and acquires the presenter right again. As shown in FIG. 9, the employee X, who is the second presenter, performs writing on the viewing terminal 50 in the first page of the distributed data. A matter written by the employee X, who is the second presenter, is represented as rendering data B. The employee A, who is the third presenter, performs wiring on the viewing terminal 50 in the first page of the distributed data. A matter written by the employee A, who is the third presenter, is represented as rendering data C.

In the conference supporting system 100 according to this embodiment, a person called presenter and a person called viewer are present among participants in a conference supported by the conference supporting system 100.

There is a “sharing mode” for the presenter (a presenter terminal). There are a “sharing mode” and an “independent mode” for the viewer (a viewing terminal). In the case of the “sharing mode”, data rendered on the presenter terminal (the viewing terminal 50 is used as the presenter terminal as well) by the presenter (a person who acquires the presenter right) is sequentially reflected on the viewing terminal 50 of the viewer. In this case, if the viewer switches the mode-switching instruction section 88 of the viewing terminal 50 of the viewer to the “sharing mode”, the viewer may not be able to add writing. On the other hand, if the viewer switches the mode-switching instruction section 88 of the viewing terminal 50 of the viewer to the “independent mode”, data rendered by the viewer is accumulated in the server 1 for each individual as rendering data of the viewer. However, the data rendered by the presenter is not reflected on the viewing terminal 50 in the independent mode. The change of the presenter is recognized by inputting, for example, an ID of the presenter to the presenter terminal.

Treatment of data additionally written by the presenter and the viewer as explained above is explained below.

### Scene 1

In “2010091711000-management conference”, when the first presenter A additionally writes a character “A”, the character consists of rendering objects “symmetrical two oblique lines” and “lateral line”. The rendering objects are managed in a unit of a rendering page. In this case, “A” rendered by the first presenter A is added to the additional-data managing section 30 and a pointer 1 is allocated to “A”.

### Scene 2

When the presenter is changed to the employee X, who is the second presenter, the employee X can select whether the employee X takes over rendering data rendered so far. If the employee X takes over the rendering data the employee X, “A” of the addition DB for display 51 is retained and kept displayed on the screen. This state is shown in FIG. 7. If the employee X does not take over the rendering data, a rendering page of “A” stored in the addition DB for display 51 is discarded and nothing is displayed on the screen.

When the employee X, who is the second presenter, renders “B”, if the employee X takes over the rendering data, “A” and “B” are displayed. In the addition DB for display 51, “B” is added after “A”. This state is shown in FIG. 8. If the employee X does not take over the rendering data, only rendering data “B” is added to the addition DB for display 51. This state is shown in FIG. 9. In this case, “B” rendered by the employee X, who is the second presenter, is added to the additional-data managing section 30 and a pointer 2 is allocated to “B”.

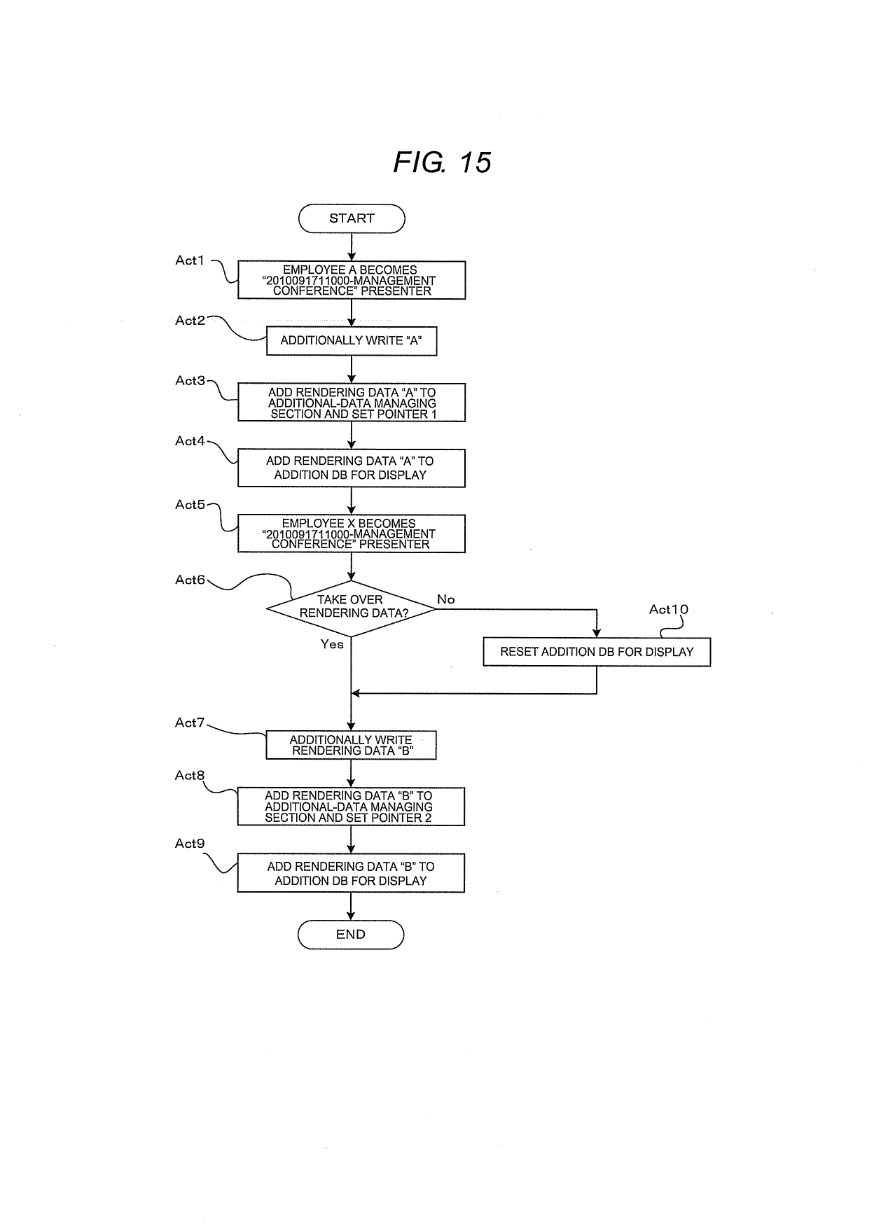

A flow of the processing explained above is shown in a flowchart of FIG. 15. The processing from the presentation of the first presenter until the rendering data “B” is added to the addition DB for display 51 is explained below on the basis of the flowchart of FIG. 15.

In Act 1, the employee A becomes the first presenter of “2010091711000-management conference”. When the employee A operates the presenter terminal to perform prevention, and additionally writes a character A on the presenter terminal (Act 2), the conference supporting system 100 proceeds to Act 3. In Act 3, the conference supporting system 100 adds rendering data “A” to the additional-data managing section 30, sets the pointer 1, and proceeds to Act 4. In Act 4, the conference supporting system 100 ads the rendering data “A” to the addition DB for display 51 and proceeds to Act 5. In Act 5, the employee A changes to the employee X, who is the second presenter. The conference supporting system 100 proceeds to Act 6.

In Act 6, the second presenter determines whether the second presenter takes over the rendering data of the first presenter. If the second presenter takes over the rendering data (Yes), the conference supporting system 100 proceeds to Act 7. If the second presenter does not take over the rendering data, the conference supporting system 100 proceeds to Act 10. When the second presenter takes over the rendering data of the first presenter, the addition DB for display 51 is retained as it is and “A” is displayed on the screen of the viewing terminal 50. On the other hand, in Act 10, the conference supporting system 100 resets the addition DB for display 51, erases the rendering data “A” from the screen of the viewing terminal 50, and proceeds to Act 7.

In Act 7, when the employee X, who is the second presenter, renders “B” on the presenter terminal, the conference supporting system 100 adds “B” to the addition DB for display 51 and proceeds to Act 8. In Act 8, the conference supporting system 100 adds rendering data “B” to the additional-data managing section 30, sets the pointer 2, and proceeds to Act 9. In Act 9, the conference supporting system 100 adds the rendering data “B” to the addition DB for display 51, displays “B” on the screen of the viewing terminal 50, and ends the processing.

The employee A is the first presenter when the employee X is the second presenter is currently a viewer. Therefore, the employee A switches a switching mode of the viewing terminal 50 of the employee A to the independent mode. Therefore, the employee A, who is the viewer, can switch the viewing terminal 50 to the “independent mode” and additionally write data on the screen main body 81. In this case, when the employee A additionally writes “C”, added rendering data is accumulated in the additional-data managing section 30 of the server 1 and a pointer 3 is allocated to the rendering data.

### Scene 3

When the employee A, who is the third presenter, acquires the presenter right again, the employee A determines whether the employee A takes over, as rendering data, the item “B” rendered by the employee X, who is the second presenter. If the employee A, who is the third presenter, selects to take over the item “B” rendered by the employee X, the employee A can select whether “C” rendered by the employee A acting as the presenter is added in addition to the item “B”.

The selection of whether additional data is added can also be performed by methods explained below.

(1) Determine additional data for each of rendering objects (e.g., “C” is added and “F” is not added”.

(2) Determine additional data by classifying the additional data according to the colors of the pens displayed in the rendering-pen-list display section 86A (e.g., red: add, blue: not add).

(3) Determine additional data on the basis of time (e.g., data until x hour yy minute is added and data after the time is not added).

(4) It is also possible to set in advance for each of the pens in use whether additional data is added, e.g., a red character is “added” and a blue character is “not added”. In that case, a character is added as additional data without being determine at the time of acquisition of the presenter right whether the character is added.

If “added” is selected, “C” is added anew in the addition DB for display 51 and “ABC” is displayed on the screen (see FIG. 10).

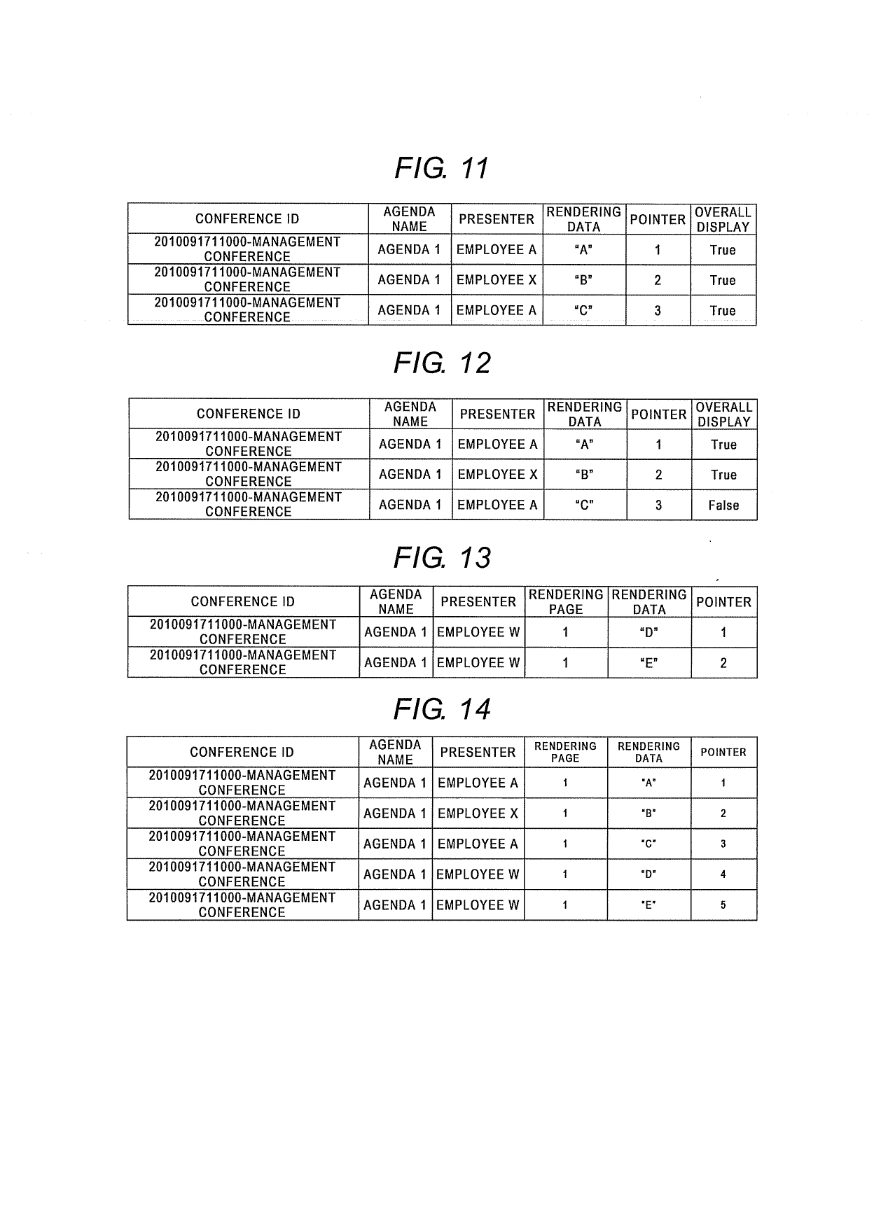

In this case, the additional-data managing section 30 performs display check of overall display. As shown in a list of the additional-data managing section 30 shown in FIG. 11, “True” is allocated to the item “C” in the item of “overall display”.

If “not added” is selected, “AB” is displayed as shown in FIG. 8. In this case, as shown in FIG. 12, False is allocated to the item “C” in the item of the overall display in the additional-data managing section 30.

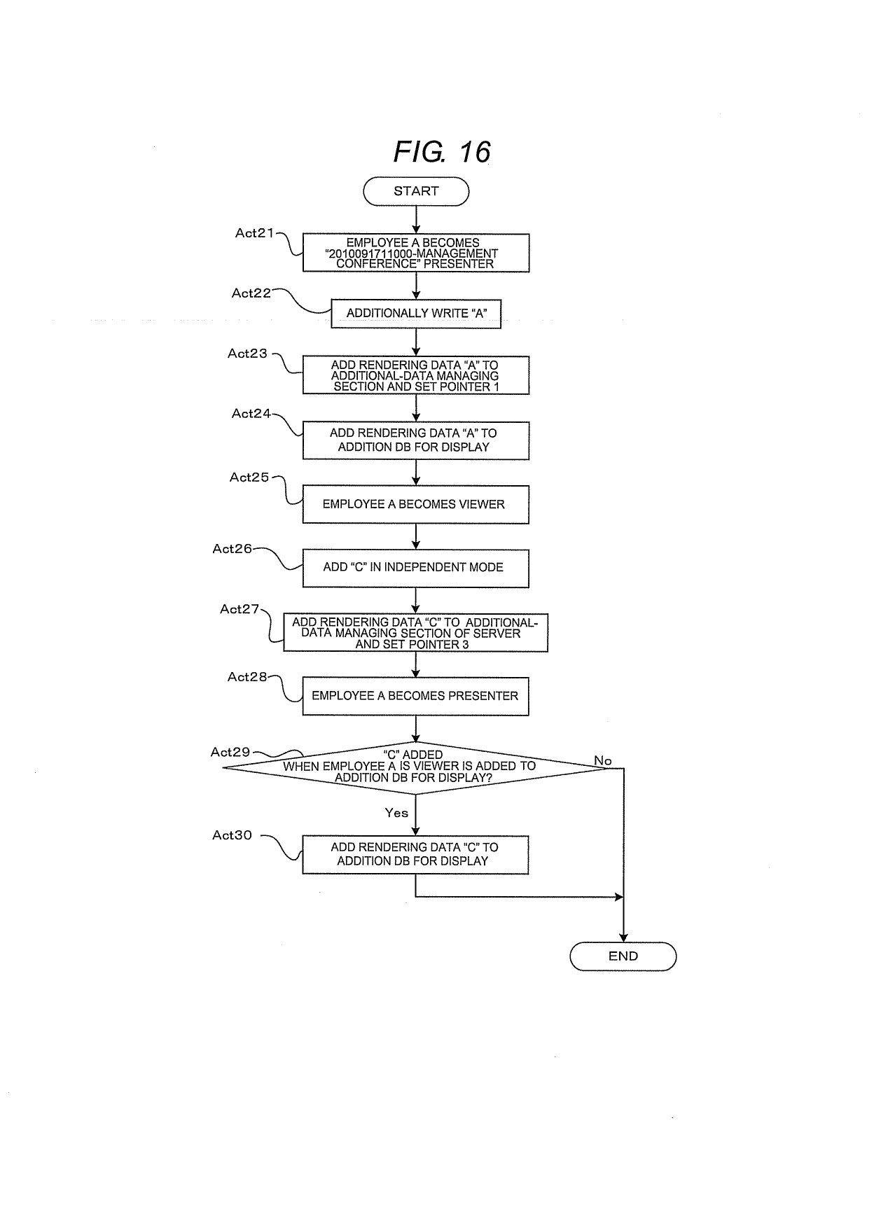

A flow of processing until rendering data “C” is added to the addition DB for display 51 after the employee A, who is the first presenter, becomes the viewer and then becomes the third presenter is shown in a flowchart of FIG. 16. In FIG. 16, Act 21 to Act 24 are the same as Act 1 to Act 4 in FIG. 15. Therefore, explanation of the acts is omitted and Act 25 and subsequent acts are explained.

In Act 25, the employee A, who is the first presenter, becomes the viewer. In Act 26, the employee A switches the viewing terminal 50 of the employee A to the independent mode and additionally writes “C”. The conference supporting system 100 proceeds to Act 27. In Act 27, the conference supporting system 100 adds “C” to the additional-data managing section 30 of the server 1, sets the pointer 3, and proceeds to Act 28.

In Act 28, the employee A becomes the third presenter. The conference supporting system 100 proceeds to Act 29. In Act 29, the conference supporting system 100 determines whether the rendering data “C” is added to the addition DB for display 51 of the viewing terminal 50. If the rendering data “C” is added (Yes), the conference supporting system 100 proceeds to Act 30 and adds the rendering data “C”. If the rendering data “C” is not added, the conference supporting system 100 ends the processing.

In an example explained above, all of the presentation terminal (which may be used as the viewing terminal 50 as well or may be provided separately from the viewing terminal 50) and the viewing terminal 50 are operating online (on the network 70). However, the same explanation applies to the viewing terminal 50 in an offline state.

The viewing terminal 50 shown in FIG. 2 changes to an offline terminal when the viewing terminal 50 is switched to the display section 88B indicating the screen private mode (referred to as independent mode). As the offline terminal, since the viewing terminal 50 is not connected to another viewing terminal, the viewing terminal 50 is in the “independent mode” of the viewer.

Contents “D” and “E” rendered in this state are accumulated in the personal-additional-data managing section 52 of the local storage as shown in FIG. 13. At a point when the viewing terminal 50 changes to online (is switched to the sharing mode), data of the personal-additional-data managing section 52 locally accumulated so far is added to the additional-data managing section 30 of the server 1 as shown in FIG. 14. When the data is added, a pointer can be added to the end of currently-present pointers as shown in FIG. 14. However, since the additional-data managing section 30 has time of addition to the personal-additional-data managing section 52, the pointer can be reset on the basis of the time.

In the examples explained above, only a rendering page 1 is referred to. However, naturally, when a rendering page is changed, the same explanation applies taking into account the concept of page management.

### Scene 4

When an employee W shares a conference acting as a viewer, for selection of additional information of a presenter, data same as rendering data displayed by the employee A, who is the current presenter, is displayed on a viewing terminal of the employee W or the employee W views rendering data of only a specific user (an employee X) among presenters in the past.

(1) Data same as rendering data displayed by the employee A, who is the current presenter, is displayed on the viewing terminal of the employee W

The server 1 acquires all pointers as rendering data from the additional-data managing section 30 and transmits the rendering data to the viewing terminal 50 of the employee W. In the viewing terminal 50, the rendering data is stored in the addition DB for display 51. The rendering data is kept in the viewing terminal 50 of the employee W and displayed.

(2) The employee W views rendering data of only a specific user (the employee X) among presenters in the past

The server 1 acquires only data of the pointer 2, which indicates that the employee X is the presenter, as rendering data from the additional-data managing sections 30 and transmits the rendering data to the viewing terminal 50 of the employee W. In the viewing terminal 50, the rendering data is stored in the addition DB for display 51. The rendering data is kept in the viewing terminal 50 of the employee W and displayed.

It is possible to view description data per user by using the scene 4 explained above. Further, it is possible to display additional data of a plurality of users on the same screen by changing, for example, a color of a pen for each of the users.

It is also possible to narrow down additional data in displaying the additional data by using the filter section 40 for the additional data. This is not only performed per user. It is also possible to display, by dividing the additional data according to time, the additional data per time as additional data 10 minutes after the start, additional data 10 minutes before the end, and additional data at x hour yy minute.

Further, respective viewers (participants) can determine whether rendering data added to the viewing terminals 50 set in the independent mode is added by switching the independent mode to the sharing mode. As an example of timing of the switching, the rendering data is checked when the presenter right is acquired.

Examples of determination for each of rendering objects are as explained below.

(1) The rendering data “A” is added and the rendering data “C” is not added.

(2) Information to be added is selected according to a color or a pen or the like, for example, information indicated by an orange color is added and information indicated by a yellow color is not added.

(3) Information to be added is determined according to a color of a pen or the like determined in advance, for example, information indicated by a red color is added and information indicated by a blue color is not added.

(4) Data to be added is determined on the basis of time, for example, data until x hour yy minute is added.

(5) Additional data to be added is determined on the basis of an event, for example, additional data before a conference is added and additional data during the conference is not added.

As a role of the additional-data managing section 30, the additional-data managing section 30 manages added rendering data for each of members or manages a pointer.

Further, in a local mode, the viewing terminal 50 can merge rendering data stored in the personal-additional-data managing section 52 by being connected to the server 1. In this case, it is also possible to reallocate pointers on a time axis and reallocate the pointers for each of users.

As a role of the addition DB for display 51 of the viewing terminal 50, for example, the addition DB for display 51 can manage data that should be displayed on the viewing terminal 50.

As a role of the filter section 40, for example, the filter section 40 selects data that should be dividedly displayed for each of users or per time and changes a color of a pen or the like for each of users or per time.

By adopting such a configuration, even if a presenter changes in a conference, it is possible to provide viewers with additional data intended by the presenter. It is possible to select display data desired by the viewers by individually managing the additional data.

In this embodiment, the viewers are enabled to perform writing with the viewing terminal 50 set in the independent mode. Therefore, for example, it is possible to display a questionnaire as a distributed material and cause the viewers to answer the questionnaire. When answers are tabulated, if data is narrowed down by the filter section 40, it is possible to obtain various kinds of information. By classifying rendering data according to colors, it is possible to classify and tabulate data for each of the color classifications.

In the embodiment, the management conference is explained as the example of the conference. However, the conference includes a training course and a seminar.

In the processing explained above with reference to FIGS. 15 and 16, a processor for internal data processing is caused to execute a computer program stored in advance in a storage region provided in the server 1. However, the computer program stored in a computer-readable recording medium may be installed in the server 1. The recording medium may be any recording medium as long as the recording medium can store the computer program and is readable by the computer. As the recording medium, for example, a RAM (Random Access Memory), a ROM (Read Only Memory), a DRAM, an SRAM (Static Random Access Memory), a VRAM (Video RAM), and a flash memory can be used.

While certain embodiments have been described, these embodiments have been presented by way of example only, and are not intended to limit the scope of the inventions . Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A conference supporting system comprising:
a material-data managing section configured to manage conference material data;
a material-data distributing section configured to distribute material data of the material-data managing section according to a distribution request;
information terminal sections configured to receive the material data through communication with the material-data distributing section and transmit rendering data generated by participants; and
an additional-data managing section configured to manage, as additional data, the rendering data transmitted from the information terminal sections, distribute, to another information terminal section, rendering data transmitted from a specific information terminal section, and determine the distribution of the rendering data according to an instruction to continuously display or not to continuously display the rendering data.

2. The system according to claim 1, wherein, when a user who uses the specific information terminal section changes, the additional-data managing section is instructed to continuously display or not to continuously display rendering data generated by the user before the change.

3. The system according to claim 2, wherein the additional-data managing section manages the rendering data for each of users.

4. The system according to claim 2, wherein the additional-data managing section manages the rendering data with a pointer affixed to each of the rendering data.

5. The system according to claim 2, wherein the information terminal sections has a sharing mode in which the information terminal sections are connected to a network and a local mode in which the information terminal sections are set in a local state, include personal-additional-data managing sections configured to store rendering data rendered by the information terminal sections in the local mode, and, when switched to the sharing mode, transmit the rendering data of the personal-additional-data managing sections to the additional-data managing section.

6. The system according to claim 1, wherein the information terminal sections include addition database for display configured to manage rendering data that should be displayed.

7. The system according to claim 1, further comprising a filter section configured to filter individual rendering data or all rendering data managed by the additional-data managing section and switch contents to be displayed to specific information.

8. The system according to claim 1, wherein the additional-data managing section determines, according to a creator of the rendering data, the instruction to continuously display or not to continuously display the rendering data.

9. The system according to claim 1, wherein the additional-data managing section determines, according to a display color of the rendering data, the instruction to continuously display or not to continuously display the rendering data.

10. The system according to claim 1, wherein the additional-data managing section determines, according to time, the instruction to continuously display or not to continuously display the rendering data.
